(19) United States
(12) Patent Application Publication
(10) Pub. No.: US 2011/0011134 A1
(43) Pub. Date: Jan. 20, 2011

(54) INJECTOR FOR HYDROGEN AND OXYGEN BUBBLING IN GLASS BATHS

(76) Inventor: Andrew P. RICHARDSON, Clinton, NJ (US)

Correspondence Address: The BOC Group, Inc., 575 MOUNTAIN AVENUE, MURRAY HILL, NJ, 07974-2082, US

(21) Appl. No.: 12/503,104

(22) Filed: Jul. 15, 2009

(51) Int. Cl. C03B 5/193; C03B 5/16

(52) U.S. Cl. 65/134.4; 65/180

(57) ABSTRACT

A bubbler for injecting gas bubbles into a glass bath in a melter includes an injector mounted to a bottom portion of the melter beneath the glass bath, the injector having a surface exposed to the glass bath; a plurality of passageways formed in the injector extending through the injector and opening at the surface for providing the gas bubbles into the glass bath; and a controller connected to the bubbler for controlling origination and release of the gas bubbles for injection into the glass bath.

The present embodiments are related to bubbling with gas in a glass bath of a melter.

Bubbling with gases, typically air, is a common practice in glass melting as it is used to reinforce convection currents within the glass bath or melt for improving melter performance. Further increases in performance may be achieved by bubbling with a pair of reactive gases, such as hydrogen and oxygen, in glass baths to improve refining, grain dissolution and reduce foam through controlled micro-explosions that result in a shock wave permeating the glass bath. Such gases are introduced through separate lines or conduits disposed indiscriminately with respect to a bottom of the melter to be in communication with the glass bath for introduction of the gases into the glass bath. The arrangement of existing gas passages is not conducive to the controlled mixing of the bubbles and explosions thereof with respect to the melt in the glass bath.

In a column of rising bubbles the location at which bubbles come together is difficult to predict, as it is strongly influenced by local conditions at a tip of each distinct bubbler, which may itself influence local conditions depending upon installation of the bubbler. A bubble will enlarge as it rises through the glass melt, due to a decrease in pressure exerted on the bubble by the remaining head of glass melt above and a rise in bubble temperature as it moves through the hot glass. As a bubble expands, its edges become closer to adjacent bubbles and, in the case of separate reactive hydrogen and oxygen bubbles, contact occurs causing the explosive reaction between the hot gases within the bubbles.

For any given glass being melted, the glass properties such as density, temperature and viscosity, all impact bubble formation. For example, viscosity is sensitive to temperature changes. Flow rate effects bubble formation diameter and separation, with higher flow rates tending to form larger bubbles. These factors influence the bubble separation frequency, a bubble's diameter and the bubble's ascent velocity through the melt, as larger bubbles rise at a faster rate. In addition, bubble diameter and velocity can be influenced by neighboring or adjacent bubbles. The initial distance between bubbles is important, as it influences not only the initial lateral edge-to-edge distance of a plurality of bubbles but also, bubble-to-bubble flow interference.

Accordingly, control over the hydrogen and oxygen bubble interaction location is desirable because (1) if the bubbles do not contact each other within the melt, no micro explosions will occur, which is desirable; and (2) if the bubbles come together at a position too close to a bottom of the melt in the furnace, shock waves that result may disturb the layer of slowly moving or quiescent glass bounding the refractory bottom of the furnace, thus exacerbating refractory wear.

For a more complete understanding of the present embodiments, reference may be had to the following detailed description of the embodiments taken in conjunction with the drawing figures, of which:

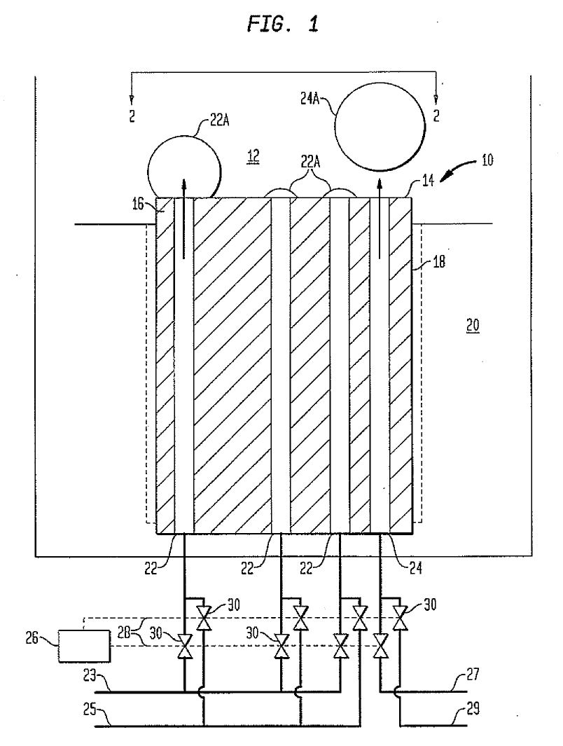

FIG. 1 shows an injector embodiment in cross-section for producing bubbles;

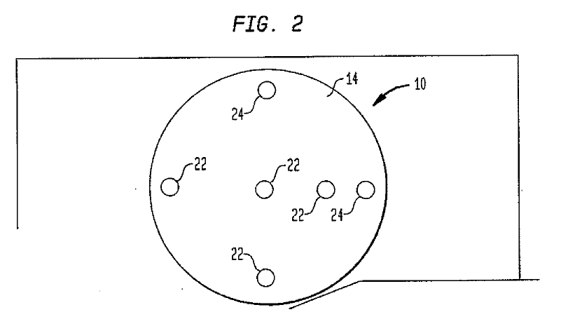

FIG. 2 shows a top plan view of the injector embodiment taken along line 2-2 in FIG. 1;

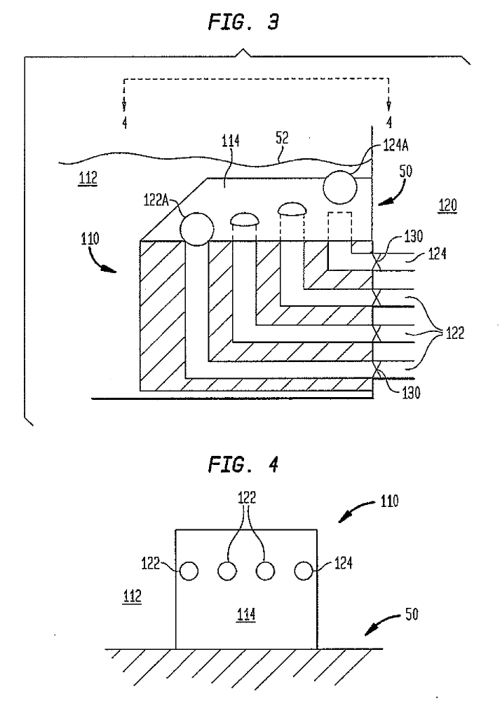

FIG. 3 shows another injector embodiment in cross-section for producing bubbles; and

FIG. 4 shows a top plan view of the injector embodiment taken along line 4-4 in FIG. 3.

Referring to FIGS. 1 and 2, the embodiment is for providing hydrogen (H₂) and oxygen (O₂) through separate passages constructed and arranged in a single bubbler or injector device shown generally at 10 for a glass melt 12 or bath. So that bubbles interact at a desired location above the bubbler in the glass bath 12, the injector 10 includes a plurality of injection holes for at least one of the oxygen and hydrogen. The holes may be located across a top edge 14 or surface of the injector 10, or through a sidewall 16 of the injector 10 if it protrudes into the glass bath 12 (discussed with respect to FIGS. 3, 4 below). The holes are distributed such that the selection of any two holes will yield different hole center distances.

The injector 10 may be constructed as a separate integral unit which is mounted or releaseably mounted into a bore 18 of a furnace bottom 20. The injector may be mounted within a refractory bubbler block which is constructed integral with the bottom of the furnace or melter. The injector 10 may also be cast as a portion of the furnace bottom 20, such as for example if the furnace is constructed of modular parts joined together. With either construction, at least one passageway 22 is formed in the injector 10 for providing oxygen, while at least one passageway 24 is formed in the injector 10 for providing hydrogen. FIG. 2 shows by way of example, not by limitation, an arrangement of the passageways 22, 24 with respect to providing oxygen bubbles 22A and hydrogen bubbles 24A.

A controller 26 is connected by control lines 28 to control valves 30 or other types of bubble initiators. The control valves 30 are mounted to gas supply lines which are connected to respective ones of the passageways 22, 24, to emit bubbles through the passageways 22, 24 at a select frequency for such emissions, which are discussed further below. A gas supply line 23 is connected to a high pressure oxygen (O₂) source. A gas supply line 25 is connected to a low pressure O₂ source. A gas supply line 27 is connected to a high pressure hydrogen (H₂) source; while a gas supply line 29 is connected to a low pressure H₂ source.

The gas supply lines 23, 25, 27, 29 (collectively referred to as “23-29”) to the injector 10 can operate continuously or in a pulsating manner, by the controller 26 controlling the valves 30. The injector 10 operates by the controller 26 switching a gas supply to the injector 10 from a low or holding pressure phase, to a high pressure phase. During the low pressure phase, the pressure is such that the gas inhibits molten glass from the glass bath 12 from flowing into the passageways 22, 24 by maintaining a bubble cap 22A at the passageway exit as shown in FIG. 1. See for example the central passageways 22. A bubble cap for the hydrogen gas passageway 24 may be provided as well by the gas line 29. During the high pressure phase, the controller 26 sends gas flows through the injector 10 at a rate determined by the supply pressure and the pressure within the bubble. As shown in FIG. 1, the controller 26 has controlled the valve 30 at the gas line 27 to provide H₂ at a higher pressure, thereby providing a bubble 24A of hydrogen emitted into the glass bath 12. In this way, bubbles are created at a rate determined by the frequency of switching between the high and low pressure phases. The ability to vary the separation frequency of each oxygen bubble 22A and hydrogen bubble 24A independently gives control over the timing of release of each bubble and hence, more control over when and where the bubbles will contact each other. When operating with a pulsed supply, the injection holes of the passageways 22, 24 at the bath 12 that were not selected for use would be connected to a supply manifold operating at the holding pressure phase. In this way, the unused injectors could remain serviceable for future use if the glass conditions were to change and thus require an alternate initial separation.

FIGS. 3 and 4 show another embodiment of the gas injector which is shown generally at 110. Elements of the embodiment in FIGS. 3 and 4 which are similar to those elements of FIGS. 1 and 2 are designated by the same reference number increased by 100.

As shown in FIGS. 3 and 4, the injector 110 is disposed at a furnace bottom 120, but is introduced into the furnace bottom 120 through a sidewall 50 of the furnace. The injector 110 protrudes into the glass bath 112 beneath a surface 52 of the glass bath 112.

Passageway 122 provides oxygen; while passageway 124 provides hydrogen to the injection 110 for distribution into the glass bath 112. A top edge 114 or surface of the injector 110 as shown in FIGS. 3 and 4 faces the surface 52 of the glass bath 112. The operation of the embodiment shown in FIGS. 3 and 4 is similar to that with respect to embodiment of FIGS. 1 and 2. The difference is that the embodiment of FIGS. 3 and 4 protrudes into the glass melt from the sidewall 50 of the melter, as opposed to protruding into the glass bath 12 from the furnace bottom 20 of the melter, as shown in FIGS. 1 and 2. The gas passageways in the injector block 10, 110 are nested in an array with their respective openings at select distances from each other. Control valves 130 or other types of bubble initiators emit bubbles through the passageways 122, 124 at a select frequency for such emissions.

By controlling the initial bubble separation and separation frequency in the embodiment, this will improve the control over the location at which separate bubbles of hydrogen and oxygen will come together in the glass bath 12, 112, thus reducing risk that (i) the bubbles will not meet within the bath and thus have no beneficial influence on the process, and the bubbles do not interact too close to the furnace bottom causing refractory deterioration; and (ii) a single bubbler arrangement for the delivery of both hydrogen and oxygen reduces the number of holes within the bottom of a glass furnace and ensures accurate, reliable bubble center-to-bubble center distances.

The injector 10, 110 may be water cooled. That is, for example, the bore 18 may include a space or further passageway for providing a fluid jacket surrounding the injector 10, 110. The injector may also include a space in which the cooling fluid is disposed and circulated. Water can be circulated through the space. While the cross section of the embodiment of FIGS. 1 and 2 is shown as circular, and the cross section of the embodiment shown in FIGS. 3 and 4 is rectangular, it is understood that either of the embodiments can be constructed having any number of cross sections.

It will be understood that the embodiments described herein are merely exemplary and that a person skilled in the art may make many variations and modifications without departing from the spirit and scope of the invention. All such variations and modifications are intended to be included within the present embodiments as described and claimed herein. It should be understood that the embodiments described above are not only in the alternative, but may be combined.

What is claimed is:

1. A bubbler for injecting gas bubbles into a glass bath in a melter, comprising:
an injector mounted to a bottom portion of the melter beneath the glass bath, the injector having a surface exposed to the glass bath;
a plurality of passageways formed in the injector extending through the injector and opening at the surface for providing the gas bubbles into the glass bath;
a controller connected to the bubbler for controlling origination and release of the gas bubbles for injection into the glass bath.

2. The bubbler according to claim 1, wherein the injector is mounted within a refractory bubbler block constructed integral with the bottom portion of the melter.

3. The bubbler according to claim 1, wherein the injector is constructed and arranged to be removably mounted to the bottom portion of the melter.

4. The bubbler according to claim 1, wherein the plurality of passageways comprise at least one passageway for oxygen bubbles and at least one passageway for hydrogen bubbles.

5. The bubbler according to claim 1, further comprising a space within the injector in which cooling fluid is disposed and circulated.

6. The bubbler according to claim 5, wherein the cooling fluid comprises water circulated through the space.

7. The bubbler according to claim 1, wherein the controller comprises valves connected to the plurality of passageways for controlling the origination and release of the gas bubbles.

8. The bubbler according to claim 1, wherein the injector comprises a sidewall exposed to the glass melt, and the plurality of passageways extend through the injector and open at the sidewall for providing the gas bubbles into the glass melt.

9. The bubbler according to claim 1, wherein the bottom portion is a sidewall of the melter, and the injector is mounted through the sidewall of the melter.

10. The bubbler according to claim 1, wherein the surface of the injector faces toward an upper surface of the glass melt.

11. The bubbler according to claim 1, further comprising a gas source connected to the plurality of passageways.

12. The bubbler according to claim 11, wherein the gas source comprises an oxygen source and a hydrogen source.

13. The bubbler according to claim 1, wherein the plurality of passageways comprise at least one passageway for gas at a first pressure and at least one passageway for another gas at a second pressure lower than the first pressure.

14. A method for injecting gas bubbles into a glass bath of a melter, comprising:
providing a plurality of gas passageways in an injector disposed at a bottom portion of the melter, the plurality of gas passageways nested in an array within the injector and opening at a surface of the injector into the glass bath;
injecting oxygen gas bubbles through at least one of the plurality of gas passageways and injecting hydrogen gas bubbles through at least one of the plurality of gas passageways;
releasing the oxygen and hydrogen gas bubbles in a sequence selected from a low pressure holding phase wherein a gas passageway of the plurality of gas passageways is covered with a gas bubble cap, and a high pressure release phase wherein a gas passageway of the plurality of gas passageways forces gas bubbles into the glass bath.

15. The method according to claim 14, wherein the plurality of gas passageways comprises at least one oxygen gas passageway and at least one hydrogen gas passageway.

16. The method according to claim 14, wherein the releasing comprises providing oxygen and hydrogen gas bubbles to collide and explode at a select position in the glass bath.

17. The method according to claim 14, wherein the releasing of the oxygen and hydrogen gas bubbles comprises pulsating said bubbles into the glass bath.

18. The method according to claim 14, further comprising controlling originating of the oxygen and hydrogen gas bubbles in the gas passageways.
